(19) United States
(12) Patent Application Publication
(10) Pub. No.: US 2004/0120818 A1
(43) Pub. Date: Jun. 24, 2004

(54) Frisbee fan

(76) Inventor: Jack Lien, Kaohsiung (TW)

Correspondence Address: BIRCH STEWART KOLASCH & BIRCH, PO BOX 747, FALLS CHURCH, VA, 22040-0747, US

(21) Appl. No.: 10/325,983

(22) Filed: Dec. 23, 2002

(51) Int. Cl. A01M 3/02

(52) U.S. Cl. 416/70 A

(57) ABSTRACT

A frisbee fan comprises a fan body made from a fabric bordering by a flexible strip on the peripheral rim thereof and a folding plate clamping the fan body for generating a strong air flow. The fan body may be printed with a selected pattern. The fan body may be separated from the folding plate to become a frisbee for recreational use. The flexible strip allows the fan body be twisted and folded to a smaller size and be encased in the folding plate to facilitate carrying and storing.

### FIELD OF THE INVENTION

The present invention relates to a frisbee fan and particularly a fan that also provides the recreational function of a frisbee.

### BACKGROUND OF THE INVENTION

The commonly used fans have a round body and a handle fixedly fastened together. They usually have a bulky size and are difficult to store. To remedy this problem, some producers have developed fans with a movable handle that is foldable. While the foldable handle overcomes the storing problem, it cannot be anchored on the fan body and is not effective for generating airflow. Moreover, the conventional fans serve only the function of the fan, thus have limited value.

### SUMMARY OF THE INVENTION

In view of the aforesaid disadvantages, the primary object of the invention is to provide a frisbee fan that provides dual functions of the fan and the frisbee. The novel fan thus made offers more added value and has a greater appeal to consumers.

The frisbee fan according to the invention includes a fan body and a folding plate. The fan body is made from a fabric bordering by a flexible strip on the peripheral rim. The folding plate is fastened to a tangent side of the peripheral rim of the fan body to form a force applying zone to enable user's hand to grasp and wave the fan body. When the folding plate is grasped by the hand, it is depressed to contact the fan body flatly, thus the force applying area is expanded from point contact to -surface contact. Waving force applying on the fan is more effective. In addition, the flexible strip is foldable and allows the fan body be twisted and folded to a smaller size and encased in the folding plate to facilitate storing. Moreover, the fan body and the folding plate may be separated to become two independent items. The separated fan body may be used as a frisbee to serve recreational function.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3 is a side view of the invention.

FIG. 4 is a fragmentary sectional view of the invention.

FIG. 5 is another fragmentary sectional view of the invention.

FIG. 6 is a top view of a design profile of the invention.

FIG.7 is a schematic top view of the invention showing force distribution.

FIG. 8 is a schematic view of the invention in a use condition -1.

FIG. 9 is a schematic view of the invention in a use condition -2.

FIG. 10 is a schematic view of the invention in a use condition -3.

FIG. 11 is a schematic view of the invention in a use condition -4.

FIG. 12 is a schematic view of the invention in a use condition -5.

FIG. 13 is a schematic view of the invention showing the fan body being twisted.

FIG. 14 is a schematic exploded view of the invention for folding.

FIG. 15 is a schematic view of the invention after folded.

FIG. 16 is a sectional view of the invention after folded.

FIG. 17 is a schematic view of the invention for use as a frisbee.

FIG. 18 is an exploded view of another embodiment of the invention.

FIG. 19 is a perspective view of another embodiment of the invention.

### DESCRIPTION OF THE PREFERRED EMBODIMENTS

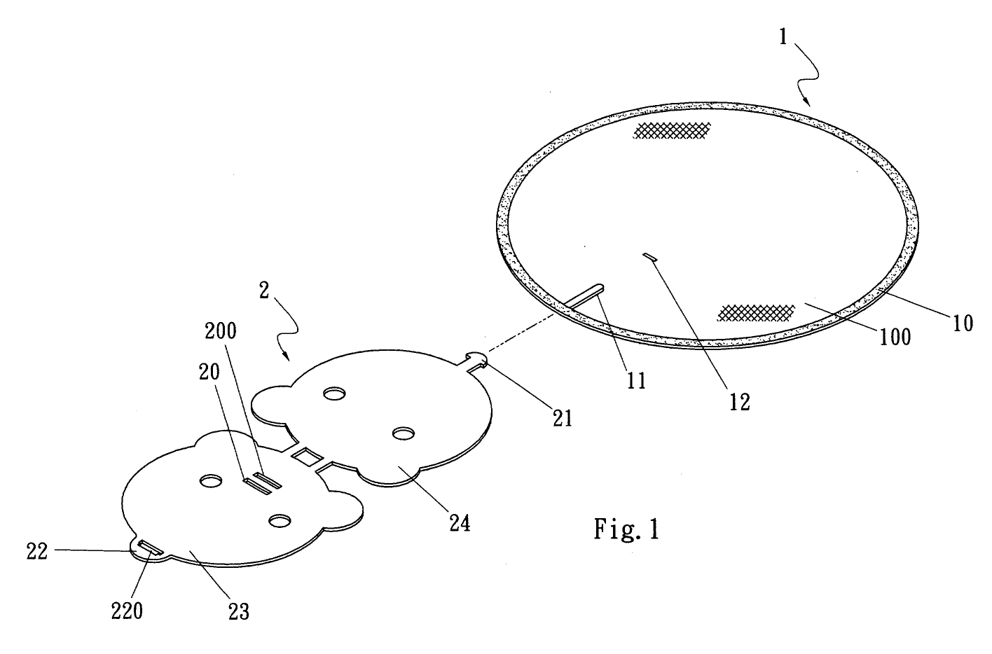

Referring to FIG. 1, the invention includes a fan body 1 and a folding plate 2. The fan body 1 is made from a fabric 100 bordering by a flexible strip 10 on the peripheral rim. The fan body 1 may be printed with patterns. The fan body 1 has a coupling blade 11 extending from a tangent side of the perimeter thereof and an anchor hole 12 formed on a desired location. The folding plate 2 is made from paper and includes a first plate 23 and a second plate 24 formed in a selected pattern and connected together. The first plate 23 has a top end with a latch member 22 formed thereon. The latch member 22 has a latch hole 220 of a selected width. The first plate 23 further has two coupling holes 20 and 200 formed on selected locations. The second plate 24 has a top end with a latch stem 21 located thereon to engage with the latch member 22. The latch stem 21 has a wider front end.

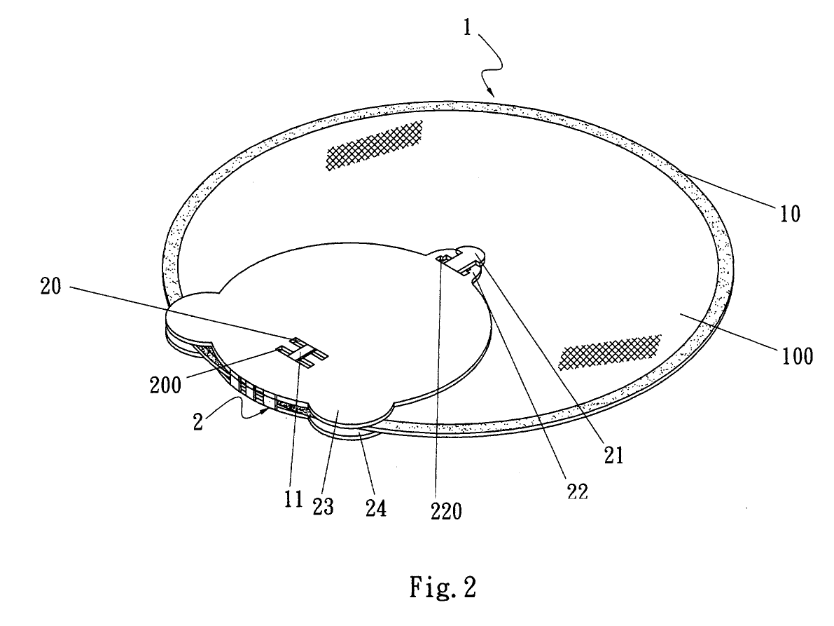

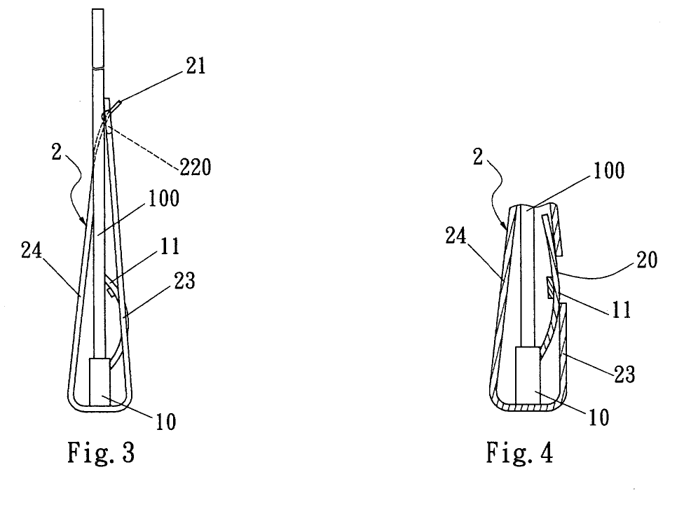

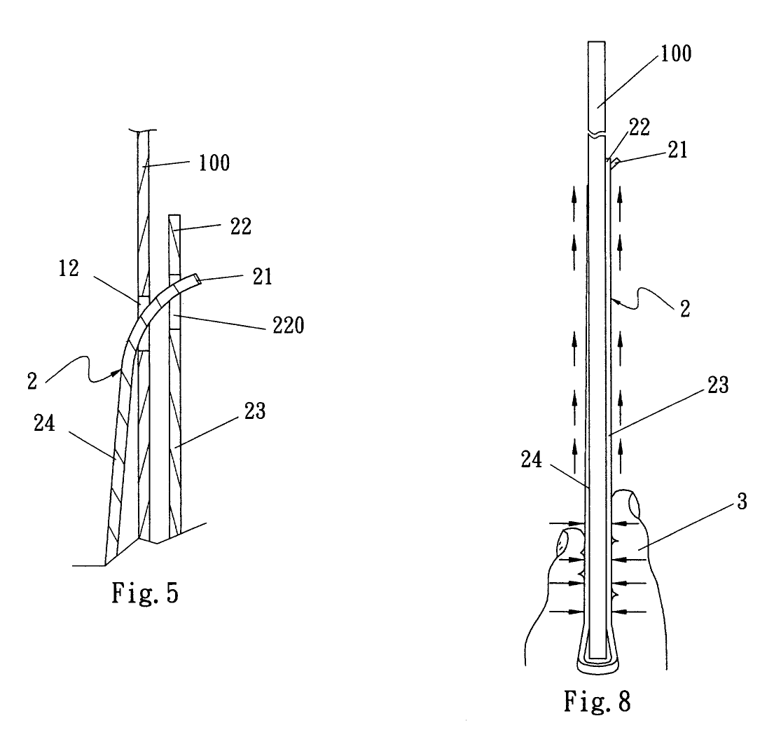

Referring to FIGS. 2 through 5, for assembly of the invention, clamp the fan body 1 from the peripheral rim with the first plate 23 and the second plate 24 of the folding plate 2, and insert the coupling blade 11 into the coupling holes 20 and 200 to form a movable fastening (as shown in FIG. 4). Then insert the latch stem 21 from one side of the fan body 1 into the latch member 22 on the other side of the fan body 1 to form a cross engagement (as shown in FIG. 5). The assembly thus formed may be disassembled and separated to become two independent items again whenever desired.

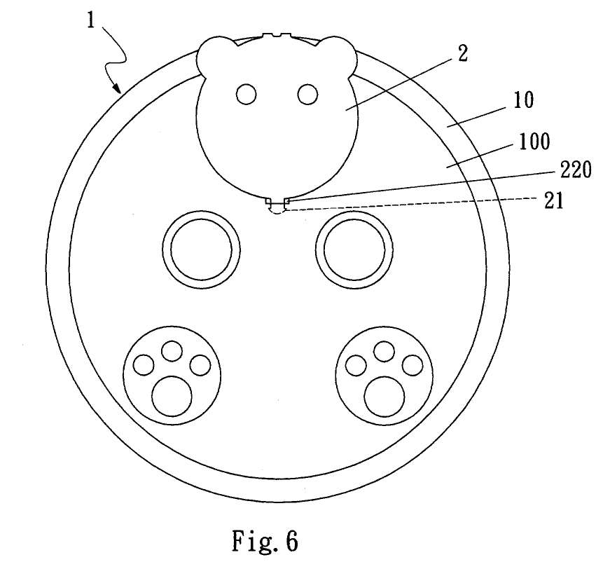

Referring to FIG. 6, the folding plate 2 may be formed with a selected profile to mate the pattern of the fan body 1 (such as a bear head shown in the drawing). Moreover, the diameter of the one plate (23 or 24) coincides with the distance between the anchor hole 12 and the tangent side of the perimeter so that the fan body 1 may be folded and encased within the folding plate 2 for storing.

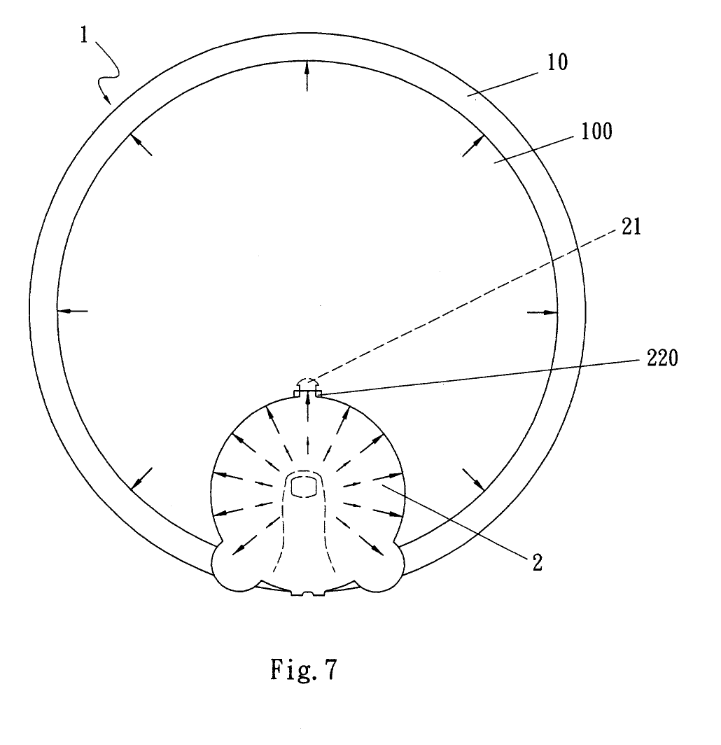

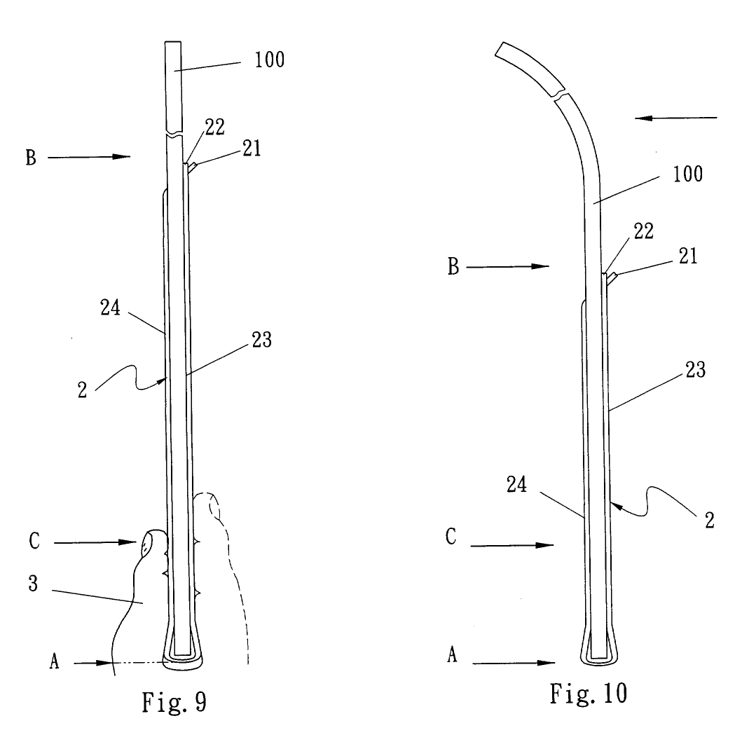

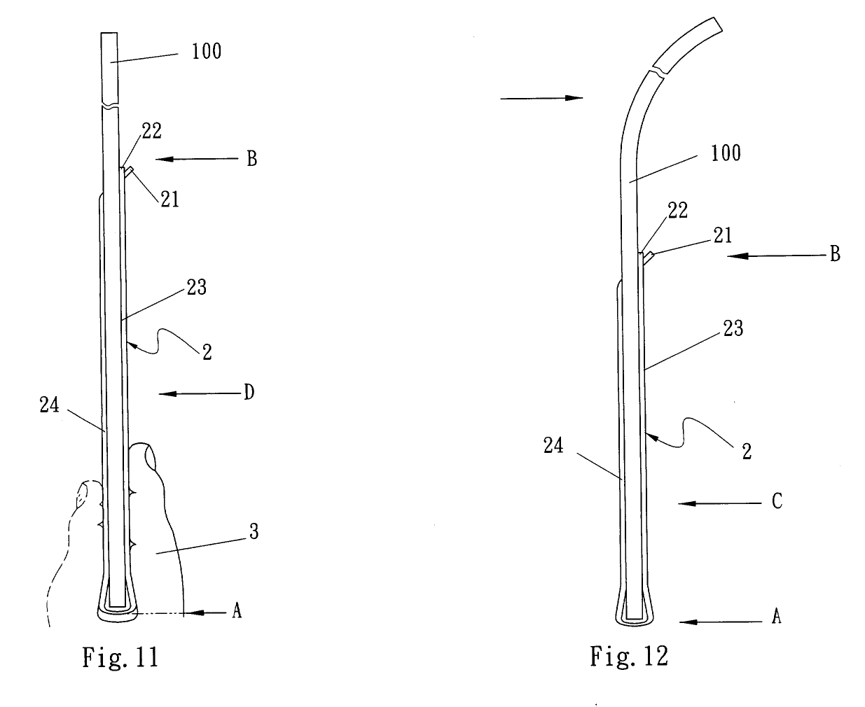

Referring to FIGS. 7 and 8, when the hand 3 clamps two sides of the folding plate 2, the entire folding plate 2 is flattened and in contact with the surface of the fan body 1. The force applying on point A is expanded to area B to become a forcing surface (as shown in FIGS. 9 and 10). When the hand waves the fan on the thrust locations C and D, the fan body is bent from the bordering rim to where the fan body is clamped by the folding plate 2 due to resistant force, thus the left and right fanning motions of the fan body can generate more airflow (referring to FIGS. 11 and 12).

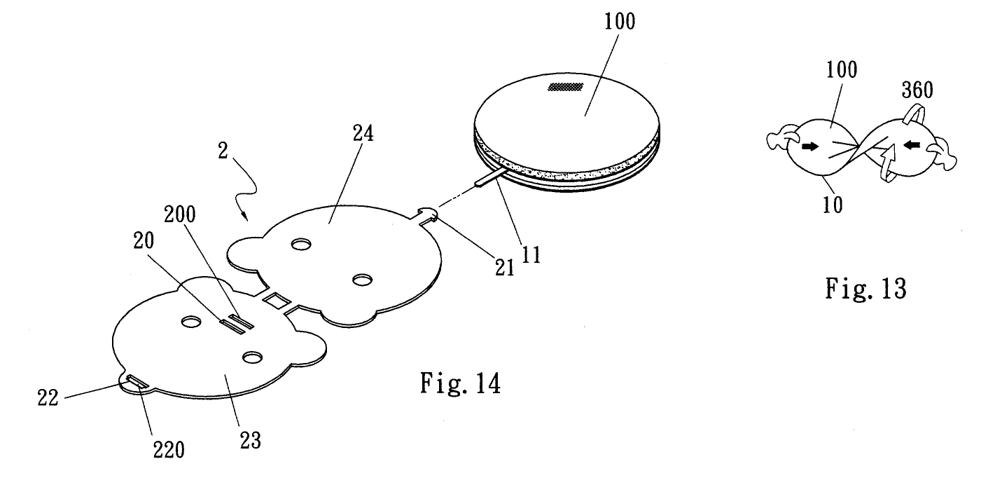

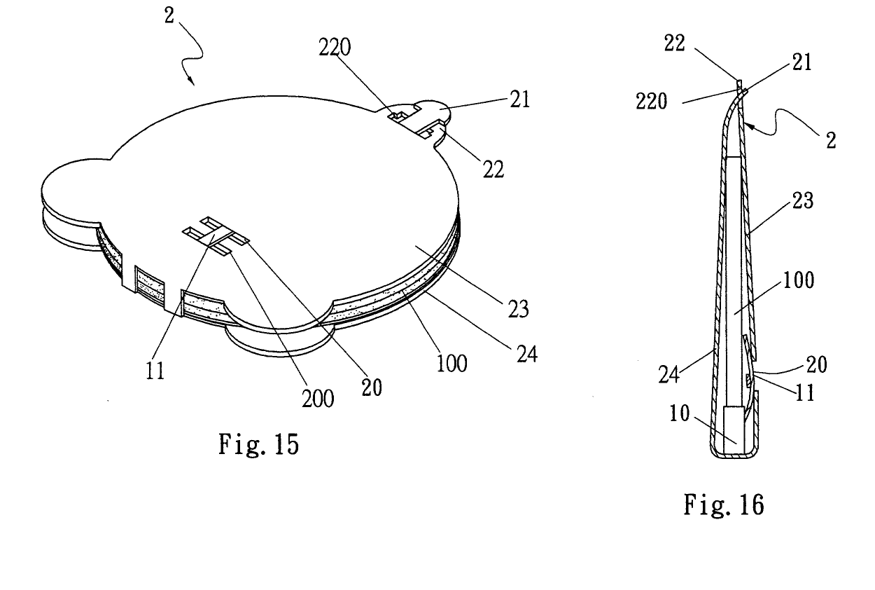

When the fan is not in use in the extending form, the flexible strip 10 may be twisted to shrink the size of the fan body 1 (as shown in FIG. 13). Then the shrunk fan body 1 may be encased within the folded folding plate 2 with the coupling blade 11 latching on the coupling hole 20 to form a storing condition (as shown in FIGS. 14, 15 and 16).

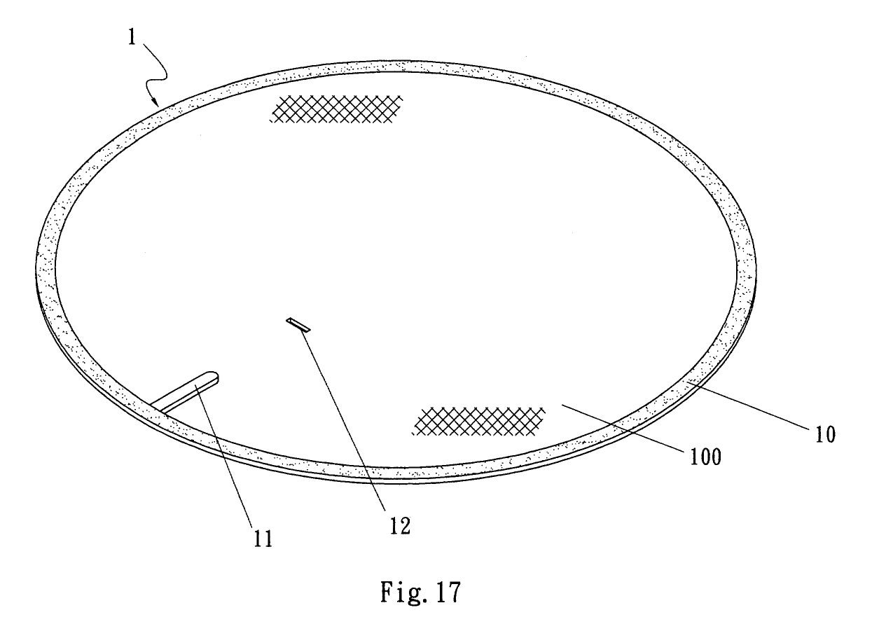

In addition, as the fan body 1 and the folding plate 2 are fastened in a semi-fixing manner, they may be separated to become two independent items. Then the fan body 1 may be used as a frisbee for recreational purpose (as shown in FIG. 17).

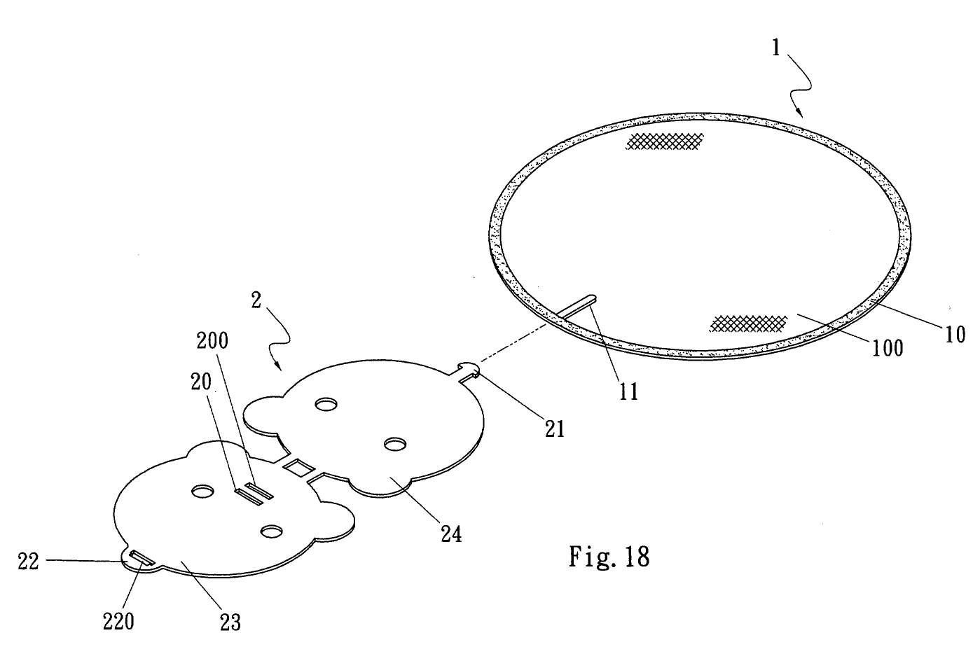

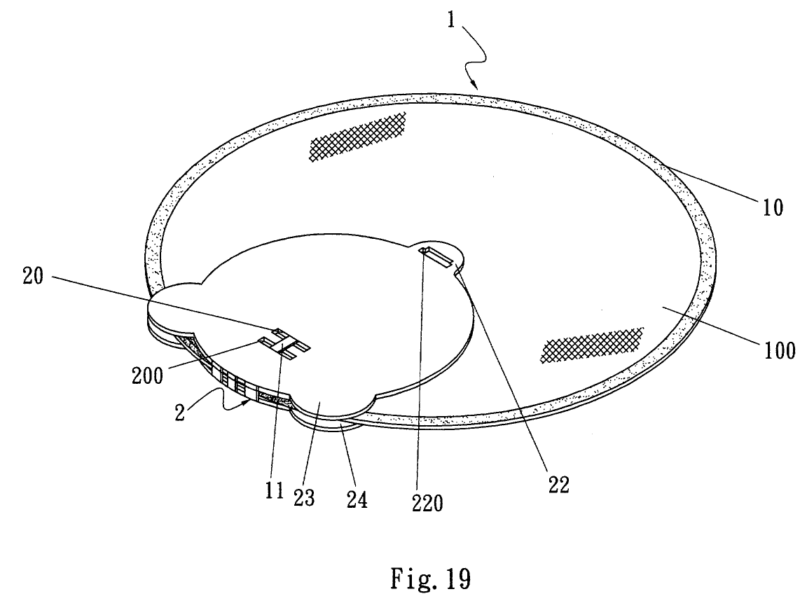

FIGS. 18 and 19 illustrate another embodiment of the invention. The fan body 1 has a flat surface. And a coupling blade 11 is provided to engage with the folding plate 2 to generate desired fan functions.

What is claimed is:

1. A frisbee fan, comprising:
a fan body made from a fabric bordering by a flexible strip on the peripheral rim thereof, the fabric having an anchor hole formed on a selected location, the fan body further having a coupling blade extending from a tangent side of the perimeter thereof; and
a folding plate consisting of a first plate and a second plate of the same size, the first plate and the second plate being connected together and having respectively a latch member and a latch stem located on a top end thereof;
wherein the fan body is clamped by the folding plate to form a fan, and the fan body is separable from the folding plate to become a frisbee for recreational use.

2. The frisbee fan of claim 1, wherein the fabric is a flat surface without the anchor hole.

3. The frisbee fan of claim 1, wherein the latch member has at least one latch hole.

4. The frisbee fan of claim 1, wherein the latch stem has one end with a greater width.

5. The frisbee fan of claim 1, wherein the latch stem is movably engageable with the fan surface.

6. The frisbee fan of claim 1, wherein the fabric is printed with a selected pattern.
